(19) United States
(12) Patent Application Publication
(10) Pub. No.: US 2023/0296265 A1
(43) Pub. Date: Sep. 21, 2023

(54) RADIATOR BLEEDING ASSEMBLY

(71) Applicant: Elmer Dockery, Central Islip, NY (US)

(72) Inventor: Elmer Dockery, Central Islip, NY (US)

(21) Appl. No.: 17/694,878

(22) Filed: Mar. 15, 2022

(51) Int. Cl. F24D 19/08; F16K 31/60

(52) U.S. Cl. CPC F24D 19/086; F24D 19/088; F16K 31/60

(57) ABSTRACT

A radiator bleeding assembly includes a receiver for receiving a housing of a bleeder valve. The receiver includes a perimeter wall having a first end and a second end. The first end is open and has a size and shape to receive the housing. A hose is attached to the second end and is in fluid communication with the first end to receive any fluid ejected by the bleeder valve. A valve actuator is mounted on the receive. The valve actuator opens the bleeder valve when the valve actuator is actuated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to radiator bleeding device and more particularly pertains to a new radiator bleeding device for ensuring that any water lost during the bleeding of a radiator valve is captures to prevent soiling of a floor surface adjacent to a radiator.

### (2) Description of Related Art Including Information Disclosed Under 37 CFR 1.97 and 1.98

The prior art relates to radiator bleeding devices which are used for facilitating the bleeding of air from a radiator.

### BRIEF SUMMARY OF THE INVENTION

An embodiment of the disclosure meets the needs presented above by generally comprising a receiver for receiving a housing of a bleeder valve. The receiver includes a perimeter wall having a first end and a second end. The first end is open and has a size and shape to receive the housing. A hose is attached to the second end and is in fluid communication with the first end to receive any fluid ejected by the bleeder valve. A valve actuator is mounted on the receive. The valve actuator opens the bleeder valve when the valve actuator is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a radiator bleeding assembly according to an embodiment of the disclosure.

FIG. 2 is a bottom view of an embodiment of the disclosure.

FIG. 3 is a side view of an embodiment of the disclosure.

FIG. 4 is a front view of an embodiment of the disclosure.

FIG. 5 is an isometric in-use view of an embodiment of the disclosure.

### DETAILED DESCRIPTION OF THE INVENTION

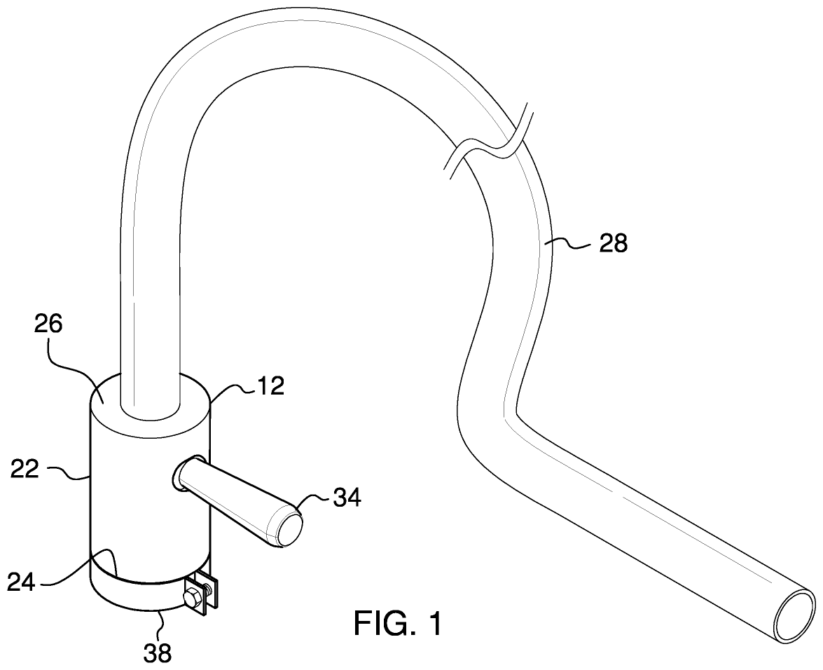

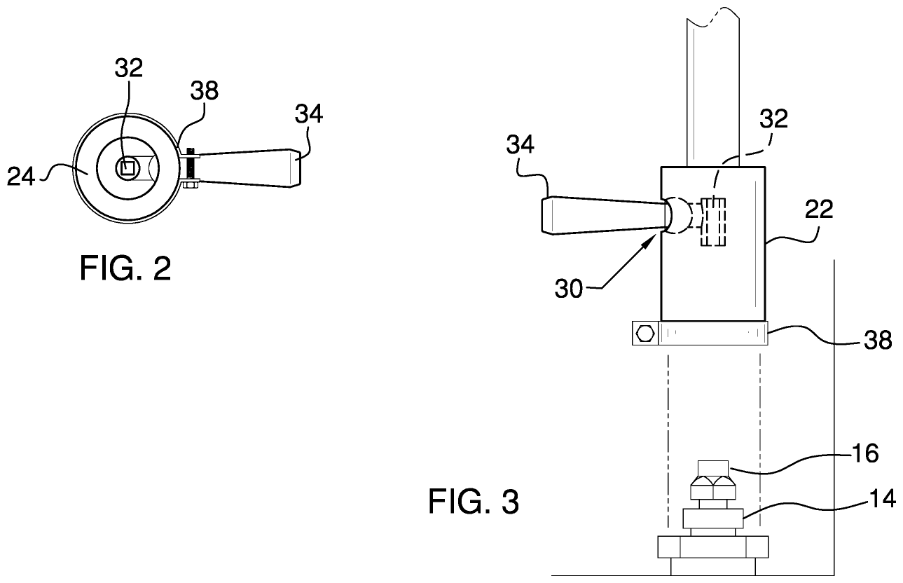

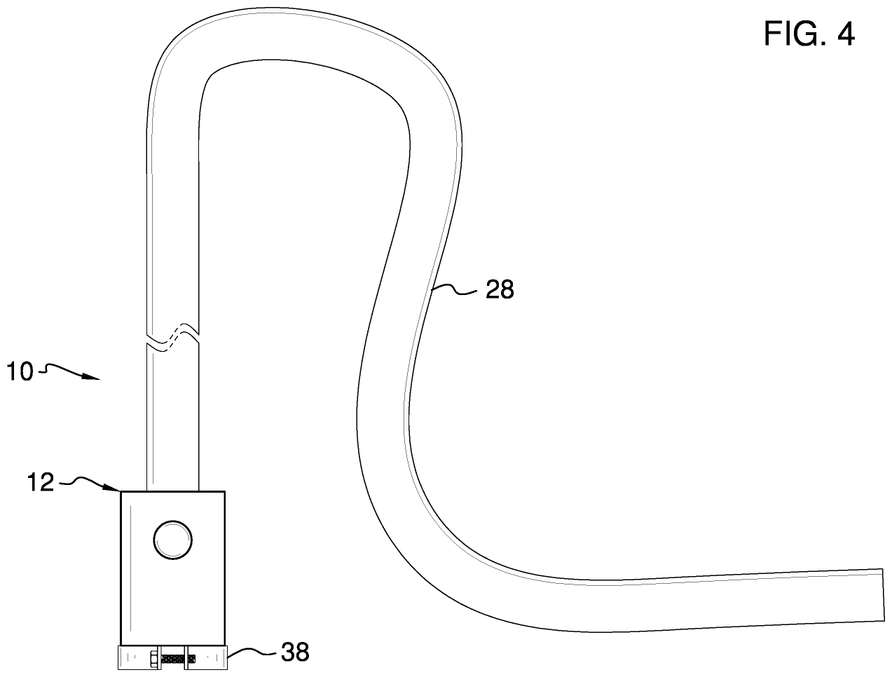

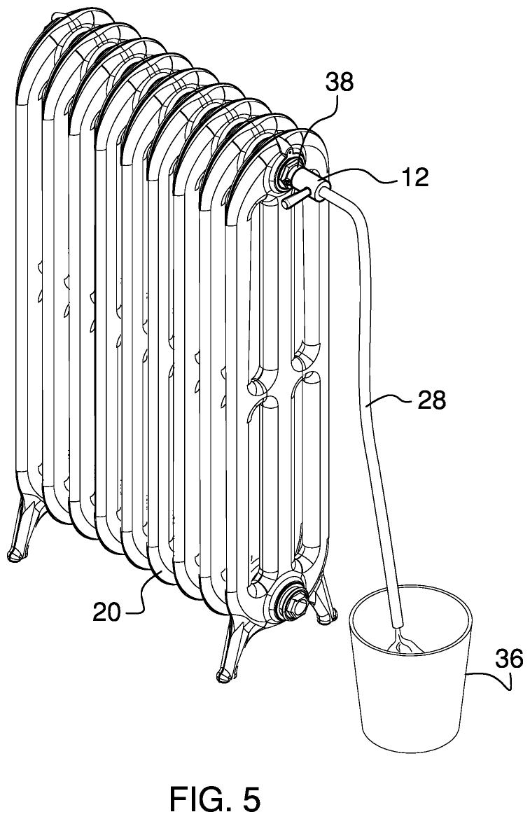

With reference now to the drawings, and in particular to FIGS. 1 through 5 thereof, a new radiator bleeding device embodying the principles and concepts of an embodiment of the disclosure and generally designated by the reference numeral 10 will be described.

As best illustrated in FIGS. 1 through 5, the radiator bleeding assembly 10 generally comprises a receiver 12 for receiving a housing 14 of a bleeder valve 16 which is fluidly coupled to a radiator 20 utilized for heating an interior space, such as a room of a dwelling. Bleeder valves are conventional and are actuated to remove air from a heating system using the radiator 20 to ensure proper functionality. The receiver 12 includes a perimeter wall 22 has a first end 24 and a second end 26. The first end 24 is open and has a size and shape to receive the housing 14. The receiver 12 typically includes a tubular member comprised of a metallic material.

A hose 28 is attached to the second end 26 and is in fluid communication with the first end 24 to receive any fluid ejected by the bleeder valve 16. The hose 28 has a length between 2.0 feet and 6.0 feet. The hose 28 will redirect any fluid which may escape the radiator 20 through the bleeder valve 16 to prevent the water from damaging a floor surface adjacent to the radiator 20. The hose 28 may be clear to facilitate the viewing of any fluid flowing through the hose 28.

A valve actuator 30 is mounted on the receiver 12. The valve actuator 30 opens the bleeder valve 16 when the valve actuator 30 is actuated. The valve actuator 30 includes a conventional valve key 32 mounted within the receiver 12. A handle 34 is mechanically coupled to the valve key 32 and extends outwardly away from the perimeter wall 22. The valve key 32 engages and opens the bleeder valve 16 when the handle 34 is actuated while the receiver 12 captures and directs any fluids to the hose 28 for collection within a container 36.

A clamp 38 may be positioned on the receiver 12 to releasably and securely couple the receiver 12 to the housing 14 of the bleeder valve 16. The clamp 38 need not be used but may be utilized to ensure that the receiver 12 and hose 28 remains in place while the bleeder valve 16 is opened. The clamp 38 may include any conventional clamping assembly for gripping the housing 14. Alternatively, or in addition to the clamp, an inner surface of the receiver 12 may include a rubber sleeve for frictionally engaging the housing 14 as well as providing a seal around the housing 14.

In use, the receiver 12 is placed on the housing 16 such that the valve key 32 can engage the bleeder valve 16. The handle 34 is actuated to open the bleeder valve 16 to remove any excess air within the heating system. Should any water leave the bleeder valve 16, it will be captured by the hose 28 and redirected for collection.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A thermostatic radiator valve actuator and drainage system comprising:
a bleeder valve having a housing;
a receiver for receiving the housing of the bleeder valve, said receiver including a perimeter wall having a first end and a second end, said first end being open and having a size and shape to receive the housing;
a hose being attached to said second end and being in fluid communication with said first end to receive any fluid ejected by the bleeder valve;
a valve actuator being mounted on said receiver, said valve actuator opening the bleeder valve when said valve actuator is actuated.

2. The thermostatic radiator valve actuator and drainage system according to claim 1, wherein said hose has a length between 2.0 feet and 6.0 feet.

3. The thermostatic radiator valve actuator and drainage system according to claim 1, wherein said valve actuator includes a valve key mounted within said receiver, a handle being mechanically coupled to said valve key, said handle extending outwardly away from said perimeter wall, said valve key engaging and opening the bleeder valve when the handle is actuated.

4. The thermostatic radiator valve actuator and drainage system according to claim 1, further including a clamp being positioned on said receiver, said clamp releasably and securely coupling said receiver to the housing of the bleeder valve.

5. A thermostatic radiator valve actuator and drainage system comprising:
a bleeder valve having a housing;
a receiver for receiving the housing of the bleeder valve, said receiver including a perimeter wall having a first end and a second end, said first end being open and having a size and shape to receive the housing;
a hose being attached to said second end and being in fluid communication with said first end to receive any fluid ejected by the bleeder valve, said hose having a length between 2.0 feet and 6.0 feet;
a valve actuator being mounted on said receiver, said valve actuator opening the bleeder valve when said valve actuator is actuated, said valve actuator including a valve key mounted within said receiver, a handle being mechanically coupled to said valve key, said handle extending outwardly away from said perimeter wall, said valve key engaging and opening the bleeder valve when the handle is actuated; and
a clamp being positioned on said receiver, said clamp releasably and securely coupling said receiver to the housing of the bleeder valve.
